(19) United States
(12) Patent Application Publication
(10) Pub. No.: US 2024/0214288 A1
(43) Pub. Date: Jun. 27, 2024

(54) HANDLING RADIO LINK FAILURE IN THE UU INTERFACE IN CASE OF SIDELINK RELAY

(71) Applicant: Telefonaktiebolaget LM Ericsson (publ), Stockholm (SE)

(72) Inventors: Min WANG, Luleå (SE); Antonino ORSINO, Kirkkonummi (FI)

(21) Appl. No.: 18/288,610

(22) PCT Filed: Mar. 28, 2022
(86) PCT No.: PCT/EP2022/058112

§ 371 Date: Oct. 27, 2023

Related U.S. Application Data
(60) Provisional application No. 63/186,466, filed on May 10, 2021.

(51) Int. Cl. H04L 43/0811; H04W 36/08; H04W 76/19; H04W 92/18

(52) U.S. Cl. CPC H04L 43/0811; H04W 36/08; H04W 76/19; H04W 92/18

(57) ABSTRACT

A method performed by a Layer 2, L2, UE-to-Network Relay User Equipment, UE, in a 5G telecommunication network, wherein said Relay UE is arranged to provide functionality to support connectivity for a remote UE in said 5G telecommunication network, said method including the steps of detecting, by said Relay UE, a Radio Link Failure, RLF, in an interface between the Relay UE and a network node of the 5G telecommunication network, upon detection of said RLF, signalling, by said Relay UE, at least one of the following information to said remote UE: RLF has been detected by said Relay UE, said Relay UE has recovered from said detected RLF and/or said Relay UE has not recovered from said detected RLF.

### INTRODUCTION

FIG. 1 illustrates an example of a new radio (“NR”) network (e.g., a 5th Generation (“5G”) network), network node 120 (e.g., a 5G base station (“gNB”)), multiple communication devices 110a-b (also referred to as user equipment (“UE”)). In this example, communication device 110a may be communicative coupled with the network node 120 via a Uu interface and communicatively coupled with communication device 120b through a sidelink interface. As a result communication device 110a may be referred to as a relay communication device, i.e. relay user equipment, and communication device 110b may be referred to as a remote communication device, i.e. remote user equipment. Traffic transmitted between a remote communication device and network node via a relay communication device can be referred to as relay traffic.

Downlink transmissions are dynamically scheduled, for example, in each slot the gNB transmits downlink control information (“DCI”) about which UE data is to be transmitted to and which resource blocks in the current downlink slot the data is transmitted on. This control information is typically transmitted in the first one or two OFDM symbols in each slot in NR. The control information is carried on the physical downlink control channel (“PDCCH”) and data is carried on the physical downlink shared channel (“PDSCH”). A UE first detects and decodes the PDCCH and if the PDCCH is decoded successfully, it then decodes the corresponding PDSCH based on the downlink assignment provided by decoded control information in the PDCCH.

In addition to PDCCH and PDSCH, there are also other channels and reference signals (“RSs”) transmitted in the downlink, including synchronization signal blocks (“SSBs”) and channel state information RSs (“CSI-RSs”).

Uplink data transmissions, carried on a physical uplink shared channel (“PUSCH”), can also be dynamically scheduled by the gNB by transmitting a DCI. The DCI (which is transmitted in the downlink (“DL”) region) always indicates a scheduling time offset so that the PUSCH is transmitted in a slot in the uplink (“UL”) region.

Sidelink transmission in NR is described below.

Sidelink transmissions over NR are specified for Rel. 16. These are enhancements of the proximity-based services (“ProSe”) specified for LTE. Four new enhancements are particularly introduced to NR sidelink transmissions and are as follows: (1) Support for unicast and groupcast transmissions are added in NR sidelink. For unicast and groupcast, the physical sidelink feedback channel (“PSFCH”) is introduced for a receiver UE to reply the decoding status to a transmitter UE; (2) Grant-free transmissions, which are adopted in NR uplink transmissions, are also provided in NR sidelink transmissions, to improve the latency performance; (3) To alleviate resource collisions among different sidelink transmissions launched by different UEs, it enhances channel sensing and resource selection procedures, which also lead to a new design of PSCCH; and (4) To achieve a high connection density, congestion control and thus the quality of service (“QoS”) management is supported in NR sidelink transmissions.

To enable the above enhancements, new physical channels and reference signals are introduced in NR (available in LTE before): (1) A physical sidelink shared channel (“PSSCH”) (e.g., a sidelink (“SL”) version of PDSCH); (2) A physical sidelink feedback channel (“PSFCH”); (3) A physical sidelink common control channel (“PSCCH”) (e.g., a SL version of PDCCH); (4) A sidelink primary synchronization signal (“S-PSS”)/sidelink secondary synchronization signal (“S-SSS”); (5) A physical sidelink broadcast channel (“PSBCH”); and (6) DMRS, phase tracking reference signal (“PT-RS”), CSI-RS.

The PSSCH is transmitted by a sidelink transmitter UE, which conveys sidelink transmission data, system information blocks (“SIBs”) for radio resource control (“RRC”) configuration, and a part of the sidelink control information (“SCI”).

The PSFCH is transmitted by a sidelink receiver UE for unicast and groupcast and conveys 1 bit information over 1 RB for the hybrid automatic repeat request (“HARQ”) acknowledgement (“ACK”) and the negative ACK (“NACK”). In addition, channel state information (“CSI”) is carried in the medium access control (“MAC”) control element (“CE”) over the PSSCH instead of the PSFCH.

When the traffic to be sent to a receiver UE arrives at a transmitter UE, a transmitter UE should first send the PSCCH, which conveys a part of sidelink control information (“SCI”) (e.g., a SL version of DCI) to be decoded by any UE for the channel sensing purpose, including the reserved time-frequency resources for transmissions, demodulation reference signal (“DMRS”) pattern, and an antenna port.

Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (“SSID”) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. The UE sending the S-PSS/S-SSS may not be necessarily involved in sidelink transmissions, and a node (e.g., UE/eNB/gNB) sending the S-PSS/S-SSS is called a synchronization source. There are 2 S-PSS sequences and 336 S-SSS sequences forming a total of 672 SSIDs in a cell.

A PSBCH is transmitted along with the S-PSS/S-SSS as a synchronization signal/PSBCH block. The SSB has the same numerology as PSCCH/PSSCH on that carrier, and an SSB should be transmitted within the bandwidth of the configured band width part (“BWP”). The PSBCH conveys information related to synchronization, such as the direct frame number (“DFN”), indication of the slot and symbol level time resources for sidelink transmissions and an in-coverage indicator. The SSB is transmitted periodically at every 160 ms.

Physical reference signals supported by NR downlink/uplink transmissions (e.g., DMRS, PT-RS, and CSI-RS) are also adopted by sidelink transmissions. Similarly, the PT-RS is only applicable for FR2 (e.g., a frequency range of 24.25-52.6 GHz) transmissions.

Another new feature is the two-stage SCI, which is a version of the DCI for SL. Unlike the DCI, only part (a first stage) of the SCI is sent on the PSCCH. This part is used for channel sensing purposes (including the reserved time-frequency resources for transmissions, DMRS pattern, and antenna port) and can be read by all UEs while the remaining (second stage) scheduling and control information such as a 8-bits source identity (“ID”) and a 16-bits destination ID, new data indicator (“NDI”), RV, and HARQ process ID is sent on the PSSCH to be decoded by the receiver UE.

Similar as for PRoSE in LTE, NR sidelink transmissions have the following two modes of resource allocations. Mode 1: Sidelink resources are scheduled by a gNB. Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants: dynamic grand and configured grant.

In regards to the dynamic grant, when the traffic to be sent over sidelink arrives at a transmitter UE, this UE should launch the four-message exchange procedure to request sidelink resources from a gNB (scheduling request (“SR”) on UL, grant, buffer status report (“BSR”) on UL, grant for data on SL sent to UE). During the resource request procedure, a gNB may allocate a sidelink radio network temporary identifier (“SL-RNTI”) to the transmitter UE. If this sidelink resource request is granted by a gNB, then a gNB indicates the resource allocation for the PSCCH and the PSSCH in the DCI conveyed by PDCCH with cyclic redundancy check (“CRC”) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (“TB”). As a result, this kind of grant is suitable for traffic with a loose latency requirement.

In regards to the configured grant, for the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions: (1) The PSSCH associated with the PSCCH for initial transmission and blind retransmissions; and (2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring reference signal received power (“RSRP”) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm can be complex.

Layer 2 (“L2”) UE-to-Network relay is described below.

In the TR 23.752 clause 6.7, the layer-2 based UE-to-Network relay is described. The protocol architecture supporting a L2 UE-to-Network Relay UE is provided. The L2 UE-to-Network Relay UE provides forwarding functionality that can relay any type of traffic over the PC5 link.

The L2 UE-to-Network Relay UE provides the functionality to support connectivity to the 5G system (“5GS”) for Remote UEs. A UE is considered to be a Remote UE if it has successfully established a PC5 link to the L2 UE-to-Network Relay UE. A Remote UE can be located within next generation radio access network (“NG-RAN”) coverage or outside of NG-RAN coverage.

FIG. 3 illustrates an example of the protocol stack for the user plane transport, related to a packet data unit (“PDU”) Session, including a Layer 2 UE-to-Network Relay UE. The PDU layer corresponds to the PDU carried between the Remote UE and the Data Network (“DN”) over the PDU session. The PDU layer corresponds to the PDU carried between the Remote UE and the DN over the PDU session. It is important to note that the two endpoints of the packet data convergence protocol (“PDCP”) link are the Remote UE and the gNB. The relay function is performed below PDCP. This means that data security is ensured between the Remote UE and the gNB without exposing raw data at the UE-to-Network Relay UE.

The adaptation relay layer within the UE-to-Network Relay UE can differentiate between signaling radio bearers (“SRBs”) and data radio bearers (“DRBs”) for a particular Remote UE. The adaption relay layer is also responsible for mapping PC5 traffic to one or more DRBs of the Uu (e.g., a UE-to-UE interface sometimes referred to as universal mobile telephone system (“UMTS”) air interface). The definition of the adaptation relay layer is under the responsibility of RAN working group two (“WG2”).

FIG. 4 illustrates the protocol stack of the non-access stratum (“NAS”) connection for the Remote UE to the NAS-mobility management (“MM”) and NAS-SM components. The NAS messages are transparently transferred between the Remote UE and 5G-AN over the Layer 2 UE-to-Network Relay UE using: PDCP end-to-end connection where the role of the UE-to-Network Relay UE is to relay the PDUs over the signaling radio bear without any modifications; N2 connection between the 5G-access network (“AN”) and access and mobility management function (“AMF”) over N2; and N11 connection AMF and session management function (“SMF”) over N11.

The role of the UE-to-Network Relay UE is to relay the PDUs from the signaling radio bearer without any modifications.

Layer 3 (“L3”) UE-to-Network relay is described below.

In the TR 23.752 clause 6.6, the layer-3 based UE-to-Network relay is described.

The ProSe 5G UE-to-Network Relay entity provides the functionality to support connectivity to the network for Remote UEs (see FIG. 5). It can be used for both public safety services and commercial services (e.g. interactive service).

A UE is considered to be a Remote UE for a certain ProSe UE-to-Network relay if it has successfully established a PC5 link to this ProSe 5G UE-to-Network Relay. A Remote UE can be located within NG-RAN coverage or outside of NG-RAN coverage. FIG. 5 illustrates an example of an architecture model using a ProSe 5G UE-to-Network Relay in TR 23.752.

The ProSe 5G UE-to-Network Relay shall relay unicast traffic (UL and DL) between the Remote UE and the network. The ProSe UE-to-Network Relay shall provide generic function that can relay any IP traffic.

One-to-one Direct Communication is used between Remote UEs and ProSe 5G UE-to-Network Relays for unicast traffic as specified in solutions for Key Issue #2 in the TR 23.752.

An example of a protocol stack for Layer-3 UE-to-Network Relays is illustrated in FIG. 6. Hop-by-hop security is supported in the PC5 link and Uu link.

If there are requirements beyond hop-by-hop security for protection of Remote UE's traffic, security over IP layer needs to be applied.

There currently exist certain challenge(s). In the WID on SL relay, the objective of this work item is to specify solutions to enable single-hop, sidelink-based, L2, and L3 based UE-to-Network (“U2N”) relaying.

Work Item objectives on aspects common to both L2 and L3 include: (1) Specifying mechanisms for U2N relay discovery and (re)selection for L3 and L2 relaying [RAN2, RAN4] (e.g., Re-use LTE relay discovery and (re)selection as baseline); and (2) Specifying mechanisms for Relay and Remote UE authorization for L3 and L2 relaying [RAN3] (e.g., Re-use LTE as baseline)

In the RAN2 #113bis, RAN2 has made the following agreement: “When Uu RLF is detected by relay UE, relay UE may send a PC5-S message (similar to LTE) to its connected remote UE(s) and this message may trigger relay reselection. FFS other indication/message can also be used for notification.” (Proposal 4). In this agreement, a relay UE may send a PC5-S signaling to a remote UE indicating of Uu RLF. Based on the indication, the remote UE may trigger relay reselection. This mechanism is the same as in LTE for L3 relay. This is mechanism may be insufficient in many cases. Especially in cases where the relay UE may be able to recover from the Uu RLF quickly, it may be better for the remote UE to not trigger relay reselection right away but rather wait and see if can still be served by the same relay UE. However, in order for the remote UE to not trigger relay reselection, other indication/message may be needed.

FIG. 7 illustrates an example of an occurrence of Uu RLF in case of SL relay. Therefore, it is necessary to study how to enhance the basic LTE like mechanism to achieve better QoS satisfaction. Even if the baseline come from L3 relay in LTE, this in NR is applicable to both L2 and L3 relay.

Certain aspects of the disclosure and their examples may provide solutions to these or other challenges. Various examples on how to indicate Uu RLF to a remote UE by a relay UE are described herein.

Various examples on how to indicate Uu RLF to a remote UE by a relay UE are described herein.

In some examples, upon detection of Uu RLF, the relay UE may signal or indicate at least one of the following information to the remote UE: (1) Uu RLF has been detected by the relay UE (with the failure type of the RLF); (2) The relay UE has recovered (or intend to recover) from detected Uu RLF successfully; and (3) The relay UE has not recovered (or not intend to recover) from detected Uu RLF successfully, so that the relay UE goes to RRC IDLE.

In additional or alternative examples, upon reception of the indication/message from the relay UE, the remote UE may apply at least one of the following options.

In some examples, the remote UE keeps connection to the relay UE and continuously communicating with the relay UE.

In additional or alternative examples, the remote UE triggers relay reselection procedure and/or cell selection/reselection procedure.

In additional or alternative examples, the remote starts a timer. The timer value may be set according to a configuration signaled by the gNB, or the relay UE.

Alternatively, the timer value may be set according to pre-configuration. to While the timer is running, the remote UE keeps connection to the relay UE. Meanwhile, the remote UE may keep communicating with the relay UE. After the timer is expired and the relay UE has not recovered from the RLF, the remote UE triggers relay reselection procedure and/or cell selection/reselection procedure. Before the timer is expired, if the relay UE has recovered from the RLF, the remote UE clears the received failure indications/messages, and continuously communicates with the relay UE.

Option 4: Suspend transmission/radio bearers towards the relay UE but does not release the PC5 link. The remote UE basically wait for another indication or a message sent by the relay UE to indicate that the relay UE recovered (or not) its Uu link.

Certain examples may provide one or more of the following technical advantage(s). In some examples, a Relay UE is able to provide rich information concerning Uu RLF to a remote UE. In additional or alternative examples, the remote UE is able to take most proper actions upon reception of indication/message from relay UE, so as to avoid interruption due to Uu RLF as much as possible. In additional or alternative examples, the remote UE can avoid triggering relay reselection or RRC reestablishment and thus incurring a long connectivity interruption.

### BRIEF DESCRIPTION OF THE DRAWINGS

The accompanying drawings, which are included to provide a further understanding of the disclosure and are incorporated in and constitute a part of this application, illustrate certain non-limiting examples of inventive concepts. In the drawings:

FIG. 1 is a schematic diagram illustrating an example of a 5^{th} generation (“5G”) network;

FIG. 2 is a schematic diagram illustrating an example of an NR physical resource grid;

FIG. 3 is a block diagram illustrating an example of a user plane stack for L2 UE-to-Network Relay UE;

FIG. 4 is a block diagram illustrating an example of a control plane stack for L2 UE-to-Network Relay UE;

FIG. 5 is a block diagram illustrating an example of an architecture model using a ProSe 5G UE-to-Network Relay;

FIG. 6 is a block diagram illustrating an example of a protocol stack for ProSe 5G UE-to-Network Relay;

FIG. 7 is a schematic diagram illustrating an example of RLF in a Uu interface associated with a sidelink relay;

FIG. 8 is a block diagram illustrating a communication device in accordance with some examples;

FIG. 9 is a block diagram illustrating a radio access network RAN node (e.g., a base station eNB/gNB) in accordance with some examples;

FIG. 10 is a block diagram illustrating a core network CN node (e.g., an AMF node, an SMF node, etc.) in accordance with some examples;

FIG. 11 is a flow chart illustrating an example of operations of a communication device for handling a RLF in accordance with some examples;

FIG. 12 is a flow chart illustrating an example of operations of a relay communication device for handling a RLF in accordance with some examples;

FIG. 13 is a flow chart illustrating an example of operations of a remote communication device for handling a RLF in accordance with some examples;

FIG. 14 is a flow chart illustrating an example of operations of a network node for handling a RLF in accordance with some examples;

FIG. 15 is a block diagram of a communication system in accordance with some examples;

FIG. 16 is a block diagram of a user equipment in accordance with some examples

FIG. 17 is a block diagram of a network node in accordance with some examples;

FIG. 18 is a block diagram of a host computer communicating with a user equipment in accordance with some examples;

FIG. 19 is a block diagram of a virtualization environment in accordance with some examples; and

FIG. 20 is a block diagram of a host computer communicating via a base station with a user equipment over a partially wireless connection in accordance with some examples in accordance with some examples.

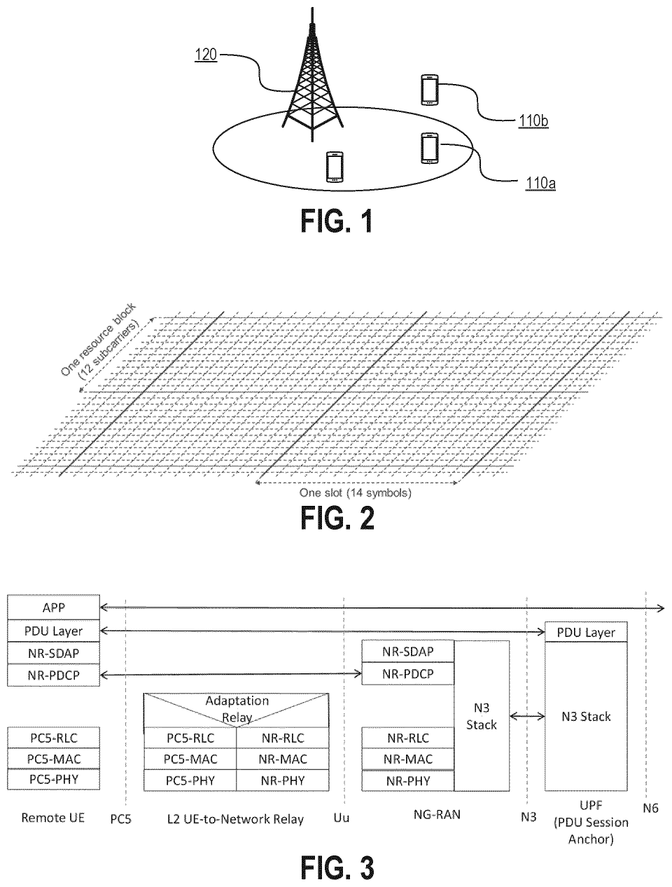

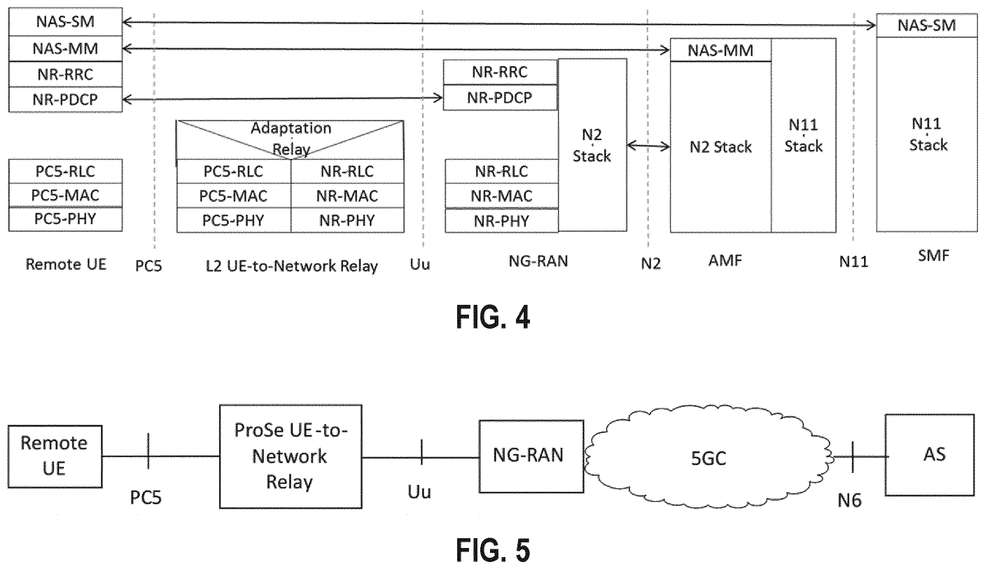

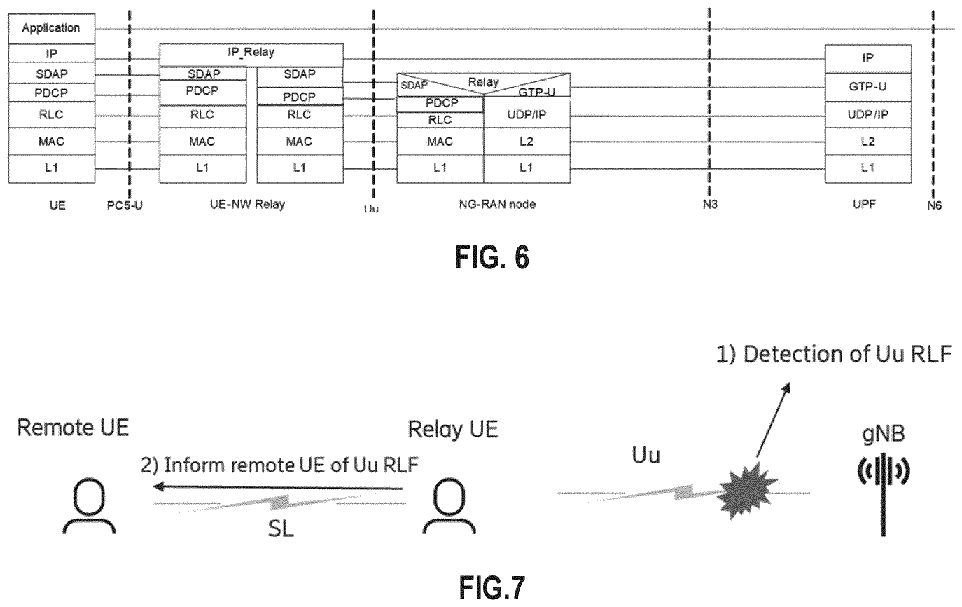

### DETAILED DESCRIPTION

Some of the examples contemplated herein will now be described more fully with reference to the accompanying drawings. Examples are provided by way of example to convey the scope of the subject matter to those skilled in the art., in which examples of examples of inventive concepts are shown. Inventive concepts may, however, be embodied in many different forms and should not be construed as limited to the examples set forth herein. Rather, these examples are provided so that this disclosure will be thorough and complete, and will fully convey the scope of present inventive concepts to those skilled in the art. It should also be noted that these examples are not mutually exclusive. Components from one example may be tacitly assumed to be present/used in another example.

In accordance with the present disclosure, there is provided a method performed by a Layer 2, L2, UE-to-Network Relay User Equipment, UE, in a mobile telecommunication network, wherein said Relay UE is arranged to provide functionality to support connectivity for a remote UE in said mobile telecommunication network, said method comprising the steps of detecting, by said Relay UE, a Radio Link Failure, RLF, in an interface between the Relay UE and a network node of the mobile telecommunication network, upon detection of said RLF, signalling, by said Relay UE, at least one of the following information to said remote UE 1) RLF has been detected by said Relay UE, 2) said Relay UE has recovered from said detected RLF, 3) said Relay UE has not recovered from said detected RLF.

The inventors have found that it might be beneficial if the Relay UE performs a particular action whenever it has detected a Radio Link Failure, RLF, in an interface between the Relay UE and the network node. More specifically, the interface may be the Uu interface between the Relay UE and the base station, i.e. gNB.

The mobile communication network may, for example, be a Service Based Architecture, SBA, based communication network like the 5G communication network.

Multiple actions are viable in accordance with the present disclosure. That is, the Relay UE may notify to the remote UE that the RLF has been detected. This allows the remote UE to take adequate actions. For example, the remote UE may decide to wait and see whether the link between the relay UE and the mobile communication network will get restored. The remote UE may also determine to find an alternative connection to the mobile communication network, for example via a direct connection or via an alternative relay UE.

The Remote UE may, for example, also maintain a counter, wherein the counter indicates how often the relay UE has indicated such an RLF. In case the counter is above a particular threshold withing a predetermined amount of time, the remote UE may decide that the relay UE does not form a stable proxy point for the remote UE and may decide to look for alternative connections to the mobile communication network.

Multiple options for the remote UE may thus exist. As discussed below, an option for the remote UE is to keep the connection to the Relay UE and to keep communicating with the Relay UE, wherein it is envisaged that the relay UE will restore the link with the mobile communication network and, once restored, the relay UE may function as a relay properly again.

Another option is that the remote UE triggers a relay reselection procedure to find an alternative suitable Relay UE that can be used for connecting to the mobile communication network. The Remote UE may also trigger a cell selection/reselection procedure if it turns out that the Remote UE intends to connect directly to a base station of the mobile communication network, i.e. the Remote UE is in range of a particular base station.

In a further example, the Remote UE may start a timer. The timer value may be set according to a configuration signalled by the gNB, or the Relay UE. Alternatively, the timer value may be set according to pre-configuration. While the timer is running, the remote UE may keep the connection to the Relay UE. Meanwhile, the Remote UE may keep communication with the Relay UE. After the timer has expired, and the Relay UE has not recovered from the RLF, the Remote UE may trigger relay reselection procedure and/or cell selection/reselection procedure. Before the timer has expires, if the Relay UE has recovered from the RLF, the remote UE may clear the received failure indications/messages, and may continuously communicate with the Relay UE.

Yet another option is that the Remote UE may suspend transmission/radio bearers towards the Relay UE but does not release the link between the Remote UE and the Relay UE, for example the PC5 link. The Remote UE may wait for a another indication or a message sent by the Relay UE to indicate that the Relay UE recovered, or not, the link between the Relay UE and the base station, i.e. the Uu link.

Following the above, it is noted that the Relay UE may notify the Remote UE that a specific Radio Link Failure, RLF, has occurred, for example in the Uu interface. Such an indication may comprise an indication of the occurrence of the RLF event, the concerned carrier index where the RLF was detected, in which serving cell the RLF is detected for example PCell, PSCell or SCell, the RLF cause, how likely the Relay UE may recover from the RLF while staying in RRC CONNECTED, estimated interruption period due to RLF assuming that the RLF can be covered, current buffer status of relaying traffic in the queue and the current buffer status of non-relaying traffic in the queue.

The RLF cause may, for example, be related to MCG RLF such as (t310-Expiry, randomAccessProblem, rlc-MaxNumRetx, beamFailureRecoveryFailure, IbtFailure, bh-rlfRecoveryFailure), The RLF cause may be related to SCG RLF such as (t310-Expiry, randomAccessProblem, rlc-MaxNumRetx, synchReconfigFailure-SCG, scg-reconfigFailure, srb3-IntegrityFailure). The RLF cause may be related to SCG EUTRA such as (t313-Expiry, randomAccessProblem,rlc-MaxNumRetx,scg-ChangeFailure,scg-IbtFailure,beamFailureRecoveryFailure, t312-Expiry).

With respect to the above, it is noted that the Relay UE may indicate how likely that it is to recover from the RLF while staying in RRC CONNECTED, reflecting at least one of the following: a success probability (0-100%), whether or not any candidate cell, in which the Relay UE is more likely to resume its activity i.e., the relay UE stays in RRC Connected) is found by the Relay UE during the cell search procedure. Such candidate cell may the same cell, a different cell from the same gNB, or a cell from a different gNB. A prepared gNB is a gNB which has admitted the UE during an earlier executed handover preparation phase, or obtains the Relay UE contaxt from inter-gNB signaling while the Relay UE stays in RRC Connected, and whether the Relay UE intends or not to perform an RLF recovery.

In addition to the above, it is noted that the Relay UE may, upon detection of the RLF in the Uu interface, slow down or suspend data transmission or reception of relay traffic in the interface between the remote UE and the Relay UE, for example the PC5 interface, to avoid potential buffer-bloat in the Relay UE.

As mentioned above, different actions may be taken by the remote UE. In addition to the above described actions it is noted that which action to take may be determined by the remote UE, by the Relay UE or by the gNB according to, for example, QoS requirements or traffic type of the relay traffic.

In an example, after the relay UE has sent the indication/message to the remote UE indicating occurrence of RLF in the Uu interface, the relay UE may perform RRC Connection re-establishment procedure in the Uu interface or any other existing RLF recovery procedure (e.g., Failure information, MCG failure information, or SCG failure information procedures).

In a further example, the relay UE cannot resume its activity when the relay UE is not able to find any suitable target cell or the RLF recovery procedure has failed. In this case, the relay UE may go to RRC IDLE, and try to setup the radio connection afterwards. In this case, the relay UE may send a second indication/message to the remote UE indicating that RLF in the Uu interface has not been recovered.

In addition to the above, if RLF is recovered in the Uu interface, the Relay UE may resume data transmission or reception of relay traffic, to or from the remote UE, which has been slowed down or suspended upon detection of RLF in the PC5 interface.

In yet another example, upon reception of the second indication/message indicating the outcome of the RLF recovery in the Uu interface from the relay UE, the remote UE may decide whether to trigger relay reselection and/or cell selection/reselection (i.e., RRC reestablishment). In case the remote UE has received the second message indicating that RLF in the Uu interface has been recovered, the remote UE may clear the received failure indications/messages, and may continuously communicate with the relay UE. In this case, if the transmission/radio bearers towards the relay UE were suspended, they may be resumed. In case the remote UE has received the second message indicating that RLF in the Uu interface has not been recovered, the remote UE may decide to trigger relay reselection procedure and/or cell selection/reselection procedure (i.e., RRC reestablishment).

In another example, when RLF is detected or determined in the Uu interface, the relay UE may not immediately send a first indication/message to the remote UE indicating occurrence of RLF. The relay UE may trigger RRC connection re-establishment or a RLF recovery procedure upon declaration of the RLF. If the relay UE cannot resume its activity due to the relay UE cannot find any suitable target cell, in this case the relay UE may go into RRC IDLE, and try to setup the radio connection afterwards. The relay UE may send a second a first indication/message to the remote UE indicating at least one of the following: an RLF has been detected in the Uu interface and/or an RLF in the Uu interface has not been recovered. Upon reception of the indication/message from the Relay UE, the remote UE may decide to trigger relay reselection procedure and/or cell selection/reselection procedure (i.e. RRC reestablishment).

In a further example, upon detection of Uu RLF, the relay UE sends an indication/message to the remote UE concerning Uu RLF (e.g., occurrence of RLF and/or outcome of RLF recovery) via at least one of the following signaling alternatives PC5-S, PC5-RRC, MAC CE, Control PDU of a protocol layer (such as SDAP, PDCP, RLC, or adaptation layer), L1 signaling carried on channels e.g., PSSCH, PSCCH, or PSFCH.

In yet another example, any necessary configuration is configured to the UE by a network node such as gNB or a UE (e.g., a controlling UE, or a relay UE) via at least one of the signaling alternatives: system information, RRC signalling (e.g., Uu RRC or PC5-RRC)—in this case, different capability/configuration may be signaled to different UEs, e.g. the gNB signals to some UEs that L2 relay is supported/preferred while signals to some other UEs that L3 relay is supported/preferred —, MAC CE, Paging message, Control PDU of a protocol layer (e.g., SDAP, PDCP, RLC, or an adaptation layer in case of SL relay), L1 signalling such as DCI, or SCI, Pre-configured (hard-coded) in the specification.

In addition, a network node such as gNB or a controlling UE includes a configuration for the remote UE in the RRC message sent to the relay UE (as separate IEs or within a container), the relay UE then forwards the configuration to the remote UE using PC5-RRC. In case the container is used, the relay UE can put the container in its PC5-RRC w/o decoding it.

Various examples herein are described in the context of NR (e.g., two or more SL UEs are deployed in a same or different NR cell). However, the same principle may be applied to LTE or any other technology that enables the direct connection of two (or more) nearby devices. Some examples are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The terms “direct connection” or “direct path” are used to stand for a connection between a UE and a gNB, while the terms “indirect connection” or “indirect path” stand for a connection between a remote UE and gNB via a relay UE. In addition, the term “path switch” is used when the remote UE changes between a direct path (e.g., Uu connection) and an indirect path (e.g., relay connection via a SL relay UE). The other term such as “relay selection/reselection” is equally applicable here without losing any meaning.

Some examples are applicable to both L2 based U2N relay scenarios and L3 based U2N relay scenarios.

In some examples, a remote UE is connected to a gNB via a relay UE. Whenever RLF is declared in the Uu interface, the relay UE sends a first indication/message to the remote UE indicating at least one of the following: (1) Occurrence of RLF event; (2) The carrier where RLF is detected; (3) In which serving cell the RLF is detected (e.g., PCell, PSCell, or SCell) (4) RLF cause; (5) How likely that the relay UE may recover from the RLF while staying in RRC CONNECTED; (6) Estimated interruption period due to RLF, if RLF can be recovered; (7) Current buffer status of relaying traffic in the queue; and (8) Current buffer status of non relaying traffic in the queue.

In some examples, the RLF cause includes RLF causes related to MCG RLF (e.g., t310-Expiry, randomAccessProblem, rlc-MaxNumRetx, beamFailureRecoveryFailure, IbtFailure, bh-rlfRecoveryFailure). In additional or alternative examples, the RLF cause includes RLF causes related to SCG RLF (e.g., t310-Expiry, randomAccessProblem, rlc-MaxNumRetx, synchReconfigFailure-SCG, scg-reconfigFailure, srb3-IntegrityFailure). In additional or alternative examples, the RLF cause includes RLF causes related to SCG EUTRA (e.g., t313-Expiry, randomAccessProblem,rlc-MaxNumRetx,scg-ChangeFailure,scg-IbtFailure,beamFailureRecoveryFailure, t312-Expiry).

In some examples, how likely that the relay UE may recover from the RLF while staying in RRC CONNECTED can be reflected by a success probability (e.g., 0-100%). In additional or alternative examples, how likely that the relay UE may recover from the RLF while staying in RRC CONNECTED can be reflected by whether or not any candidate cell (in which the relay UE is more likely to resume its activity i.e., the relay UE stays in RRC Connected) is found by the relay UE during the cell search procedure. Such candidate cell may the same cell, a different cell from the same gNB, or a cell from a different gNB. A prepared gNB is a gNB which has admitted the UE during an earlier executed HO preparation phase, or obtains the relay UE context from inter-gNB signaling while the relay UE stays in RRC CONNECTED). In additional or alternative examples, how likely that the relay UE may recover from the RLF while staying in RRC CONNECTED can be reflected by whether the relay UE intends or not to perform a RLF recovery.

In additional or alternative examples, upon detection of the RLF in the Uu interface, the relay UE may slow down or suspend data transmission or reception of relay traffic (to or from the remote UE) in the PC5 interface to avoid potential buffer-bloat in the relay UE.

In additional or alternative examples, upon reception of the first indication/message indicating occurrence of RLF in the Uu interface from the relay UE, the remote UE may take at least one of the following options.

In some examples, the remote UE triggers relay reselection procedure and/or cell selection/reselection procedure (i.e., RRC reestablishment)

In additional or alternative examples, the remote UE starts a timer. The timer value may be set according to a configuration signaled by the gNB, or the relay UE. Alternatively, the timer value may be set according to pre-configuration. to While the timer is running, the remote UE keeps connection to the relay UE. Meanwhile, the remote UE may keep communicating with the relay UE. After the timer is expired and the relay UE has not recovered from the RLF, the remote UE triggers relay reselection procedure and/or cell selection/reselection procedure. Before the timer is expired, if the relay UE has recovered from the RLF, the remote UE clears the received failure indications/messages, and continuously communicates with the relay UE.

In additional or alternative examples, the remote UE suspend transmission/radio bearers towards the relay UE but does not release the PC5 link. The remote UE basically waits for another indication or a message sent by the relay UE to indicate that the relay UE recovered (or not) its Uu link.

In additional or alternative examples, the option taken by the remote UE may be determined by the remote UE, the relay UE, or the gNB according to QoS requirements or traffic type of the relay traffic. For services or traffic type with critical QoS requirements (e.g., critical latency requirement), it may be beneficial to use the timer so as to avoid latency due to unnecessary relay reselection. For services or a traffic type with non-critical QoS requirements (e.g., non-critical latency requirements), it is may be beneficial to trigger the relay reselection or to suspend transmission and wait for another indication from the relay UE.

In additional or alternative examples, after the relay UE sends the first indication/message to the remote UE indicating occurrence of RLF in the Uu interface, the relay UE performs RRC Connection re-establishment procedure in the Uu interface or any other existing RLF recovery procedure (e.g., Failure information, master cell group (“MCG”) failure information, or secondary cell group (“SCG”) failure information procedures). Depending on whether the RRC Connection re-establishment or RLF recovery procedure is successful, the relay UE applies a different option.

In some examples, the relay UE has found a suitable target cell so that the relay UE has completed RRC connection re-establishment successfully towards the target cell or the RLF recovery procedure succeeded and thus the existing RRC connection is restored. In this case, the relay UE stays in RRC CONNECTED. The relay UE sends a second indication/message to the remote UE indicating that RLF in the Uu interface has been recovered.

In additional or alternative examples, the relay UE cannot resume its activity due to the relay UE cannot find any suitable target cell or the RLF recovery procedure has failed. In this case, the relay UE goes to RRC IDLE, and try to setup the radio connection afterwards. In this case, the relay UE sends a second indication/message to the remote UE indicating that RLF in the Uu interface has not been recovered.

In additional or alternative examples, if the RLF is recovered in the Uu interface, the relay UE can resume data transmission or reception of relay traffic (to or from the remote UE) which has been slowed down or suspended upon detection of RLF in the PC5 interface.

In additional or alternative examples, upon reception of the second indication/message indicating outcome of the RLF recovery in the Uu interface from the relay UE, the remote UE can decide whether to trigger relay reselection and/or cell selection/reselection (i.e., RRC reestablishment).

In case the remote UE has received the second message indicating that RLF in the Uu interface has been recovered, the remote UE clears the received failure indications/messages, and continuously communicates with the relay UE. In this case, if the transmission/radio bearers towards the relay UE were suspended, now they are resumed.

In case the remote UE has received the second message indicating that RLF in the Uu interface has not been recovered, the remote UE may decide to trigger relay reselection procedure and/or cell selection/reselection procedure (i.e., RRC reestablishment).

In additional or alternative examples, when RLF is declared in the Uu interface, the relay UE does not immediately send a first indication/message to the remote UE indicating occurrence of RLF. The relay UE triggers RRC connection re-establishment or a RLF recovery procedure upon declaration of the RLF. If the relay UE cannot resume its activity due to the relay UE cannot find any suitable target cell, in this case the relay UE goes to RRC IDLE, and try to setup the radio connection afterwards. The relay UE sends a first indication/message to the remote UE indicating at least one of the following: (1) RLF has been declared in the Uu interface; and (2) RLF in the Uu interface has not been recovered.

Upon reception of the indication/message from the relay UE, the remote UE may decide to trigger relay reselection procedure and/or cell selection/reselection procedure (i.e., RRC reestablishment).

In additional or alternative examples, upon detection of Uu RLF, the relay UE sends an indication/message to the remote UE concerning Uu RLF (e.g., occurrence of RLF and/or outcome of RLF recovery) via at least one of the following signaling alternatives: (1) PC5-S; (2) PC5-RRC; (3) MAC CE; (4) Control PDU of a protocol layer (e.g., service data application protocol (“SDAP”), PDCP, RLC, or adaptation layer); and (4) L1 signaling carried on channels (e.g., PSSCH, PSCCH, or PSFCH).

In additional or alternative examples, any necessary configuration is configured to the UE by a network node such as gNB or a UE (e.g., a controlling UE, or a relay UE) via at least one of the following signaling alternative: system information; RRC signalling (e.g., Uu RRC or PC5-RRC); MAC CE; paging message; Control PDU of a protocol layer (e.g., SDAP, PDCP, RLC, or an adaptation layer in case of SL relay); L1 signalling (e.g., DCI or SCI); and pre-configured (hard-coded) in the specification.

In some examples, different capability/configuration may be signaled to different UEs (e.g., the gNB signals to some UEs that L2 relay is supported/preferred while signals to some other UEs that L3 relay is supported/preferred.).

In additional or alternative examples, a network node such as gNB or a controlling UE includes a configuration for the remote UE in the RRC message sent to the relay UE (as separate IEs or within a container), the relay UE then forwards the configuration to the remote UE using PC5-RRC. In case the container is used, the relay UE can simply put the container in its PC5-RRC without decoding it.

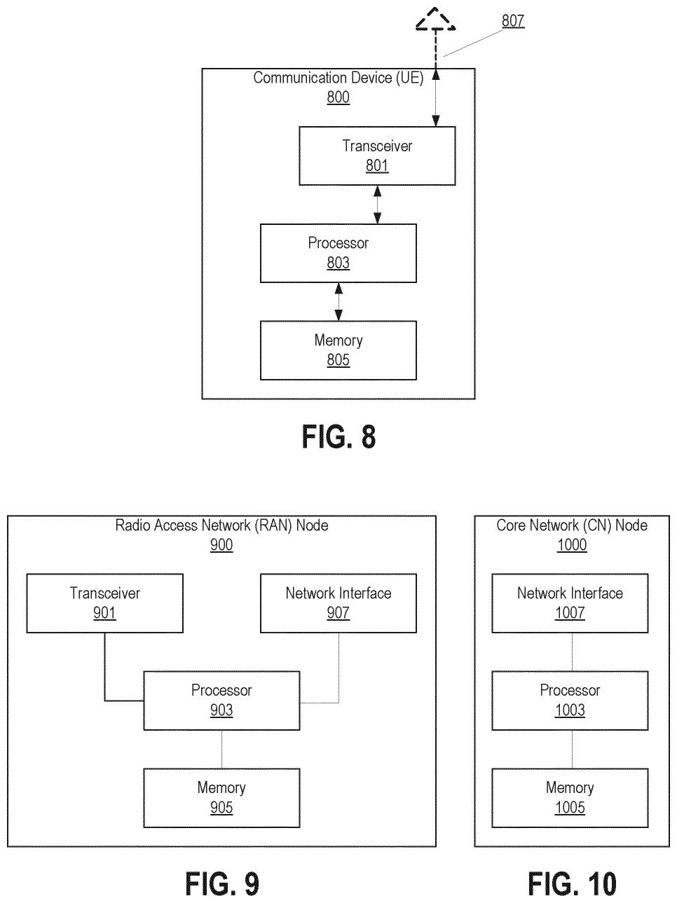

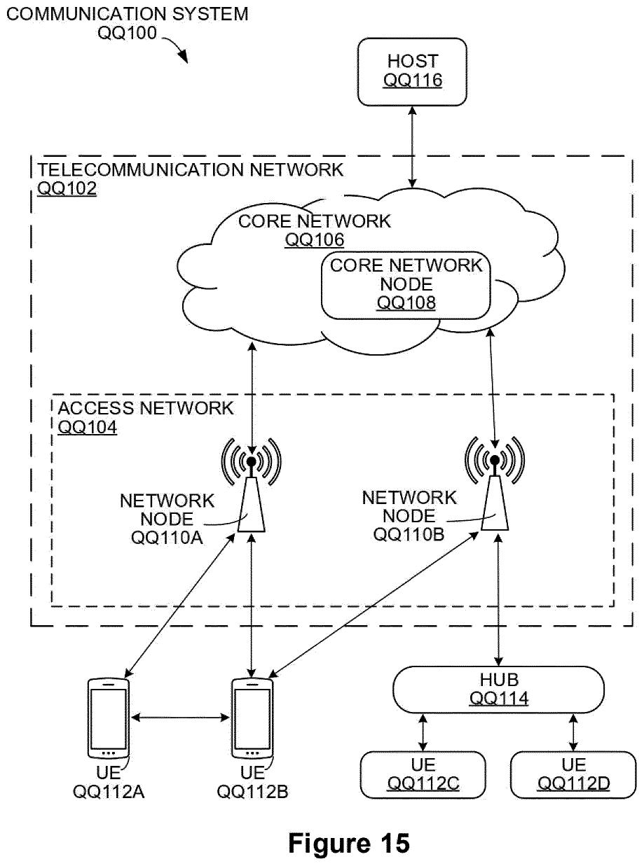

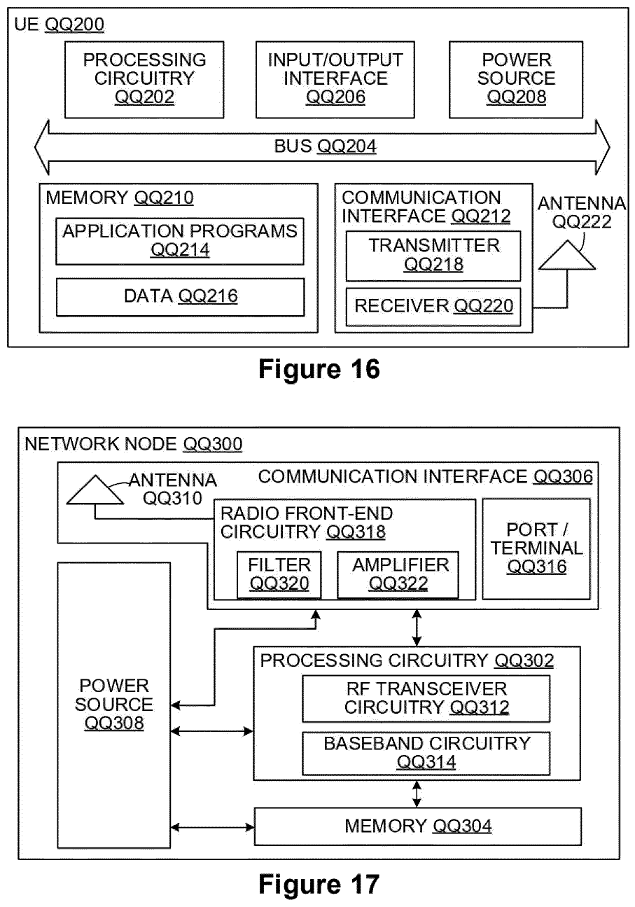

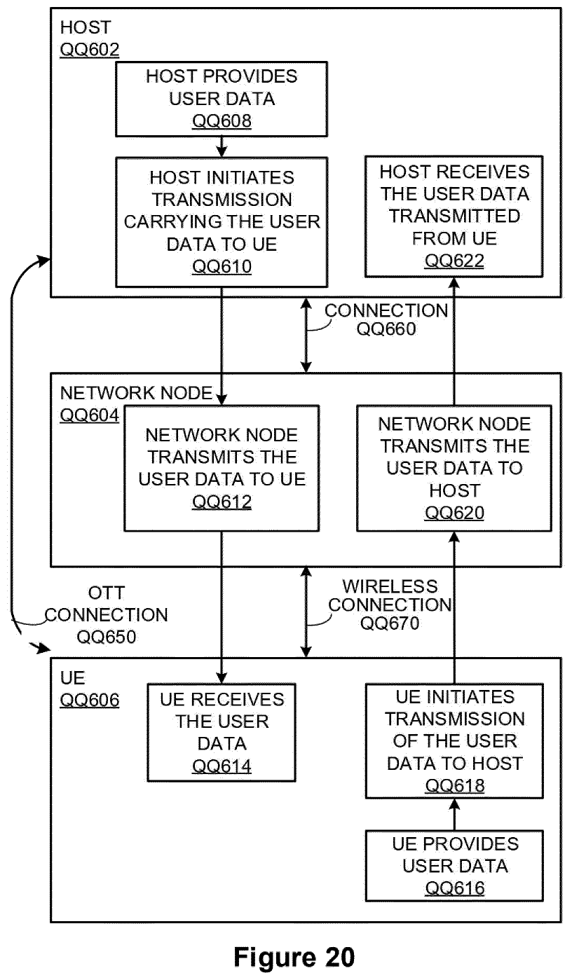

FIG. 8 is a block diagram illustrating elements of a communication device 800 (also referred to as a mobile terminal, a mobile communication terminal, a wireless device, a wireless communication device, a wireless terminal, mobile device, a wireless communication terminal, user equipment (“UE”) a user equipment node/terminal/device, etc.) configured to provide wireless communication according to examples of inventive concepts. (Communication device 800 may be provided, for example, as discussed below with respect to wireless devices UE QQ112A, UE QQ112B, and wired or wireless devices UE QQ112C, UE QQ112D of FIG. 15, UE QQ200 of FIG. 16, virtualization hardware QQ504 and virtual machines QQ508A, QQ508B of FIG. 19, and UE QQ606 of FIG. 20, all of which should be considered interchangeable in the examples and examples described herein and be within the intended scope of this disclosure, unless otherwise noted.) As shown, communication device 800 may include an antenna 807 (e.g., corresponding to antenna QQ222 of FIG. 16), and transceiver circuitry 801 (also referred to as a transceiver, e.g., corresponding to interface QQ212 of FIG. 16 having transmitter QQ218 and receiver QQ220) including a transmitter and a receiver configured to provide uplink and downlink radio communications with a base station(s) (e.g., corresponding to network node QQ110A, QQ110B of FIG. 15, network node QQ300 of FIG. 17, and network node QQ604 of FIG. 20 also referred to as a RAN node) of a radio access network. communication device 800 may also include processing circuitry 803 (also referred to as a processor, e.g., corresponding to processing circuitry QQ202 of FIG. 16, and control system QQ512 of FIG. 19) coupled to the transceiver circuitry, and memory circuitry 805 (also referred to as memory, e.g., corresponding to memory QQ210 of FIG. 15) coupled to the processing circuitry 803. The memory circuitry 805 may include computer readable program code that when executed by the processing circuitry 803 causes the processing circuitry 803 to perform operations according to examples disclosed herein. According to other examples, processing circuitry 803 may be defined to include memory so that separate memory circuitry is not required. Communication device 800 may also include an interface (such as a user interface) coupled with processing circuitry 803, and/or communication device 800 may be incorporated in a vehicle.

As discussed herein, operations of communication device 800 may be performed by processing circuitry 803 and/or transceiver circuitry 801. For example, processing circuitry 803 may control transceiver circuitry 801 to transmit communications through transceiver circuitry 801 over a radio interface to a radio access network node (also referred to as a base station) and/or to receive communications through transceiver circuitry 801 from a RAN node over a radio interface. Moreover, modules may be stored in memory circuitry 805, and these modules may provide instructions so that when instructions of a module are executed by processing circuitry 803, processing circuitry 803 performs respective operations (e.g., operations discussed below with respect to Example Examples relating to wireless communication devices). According to some examples, a communication device 800 and/or an element(s)/function(s) thereof may be embodied as a virtual node/nodes and/or a virtual machine/machines.

FIG. 9 is a block diagram illustrating elements of a radio access network (“RAN”) node 900 (also referred to as a network node, base station, eNodeB/eNB, gNodeB/gNB, etc.) of a RAN configured to provide cellular communication according to examples of inventive concepts. (RAN node 900 may be provided, for example, as discussed below with respect to network node QQ110A, QQ110B of FIG. 15, network node QQ300 of FIG. 17, hardware QQ504 or virtual machine QQ508A, QQ508B of FIG. 19, and/or base station QQ604 of FIG. 20, all of which should be considered interchangeable in the examples and examples described herein and be within the intended scope of this disclosure, unless otherwise noted.) As shown, the RAN node 900 may include transceiver circuitry 901 (also referred to as a transceiver, e.g., corresponding to portions of RF transceiver circuitry QQ312 and radio front end circuitry QQ318 of FIG. 17) including a transmitter and a receiver configured to provide uplink and downlink radio communications with mobile terminals. The RAN node 900 may include network interface circuitry 907 (also referred to as a network interface, e.g., corresponding to portions of communication interface QQ306 of FIG. 17) configured to provide communications with other nodes (e.g., with other base stations) of the RAN and/or core network (“CN”). The network node 900 may also include processing circuitry 903 (also referred to as a processor, e.g., corresponding to processing circuitry QQ302 of FIG. 17) coupled to the transceiver circuitry 901, and memory circuitry 905 (also referred to as memory, e.g., corresponding to memory QQ304 of FIG. 17) coupled to the processing circuitry. The memory circuitry 905 may include computer readable program code that when executed by the processing circuitry 903 causes the processing circuitry 903 to perform operations according to examples disclosed herein. According to other examples, processing circuitry 903 may be defined to include memory so that a separate memory circuitry 905 is not required.

As discussed herein, operations of the RAN node 900 may be performed by processing circuitry 903, network interface 907, and/or transceiver 901. For example, processing circuitry 903 may control transceiver 901 to transmit downlink communications through transceiver 901 over a radio interface to one or more mobile terminals UEs and/or to receive uplink communications through transceiver 901 from one or more mobile terminals UEs over a radio interface. Similarly, processing circuitry 903 may control network interface 907 to transmit communications through network interface 907 to one or more other network nodes and/or to receive communications through network interface from one or more other network nodes. Moreover, modules may be stored in memory 905, and these modules may provide instructions so that when instructions of a module are executed by processing circuitry 903, processing circuitry 903 performs respective operations (e.g., operations discussed below with respect to Example Examples relating to RAN nodes). According to some examples, RAN node 900 and/or an element(s)/function(s) thereof may be embodied as a virtual node/nodes and/or a virtual machine/machines.

According to some other examples, a network node may be implemented as a core network (“CN”) node without a transceiver. In such examples, transmission to a wireless communication device UE may be initiated by the CN node so that transmission to the wireless communication device UE is provided through a network node including a transceiver (e.g., through a base station or RAN node).

According to examples where the network node is a RAN node including a transceiver, initiating transmission may include transmitting through the transceiver.

FIG. 10 is a block diagram illustrating elements of a CN node (e.g., an SMF (session management function) node, an AMF (access and mobility management function) node, etc.) of a communication network configured to provide cellular communication according to examples of inventive concepts. (CN node 1000 may be provided, for example, as discussed below with respect to core network node QQ108 of FIG. 15, hardware QQ504 or virtual machine QQ508A, QQ508B of FIG. 19, all of which should be considered interchangeable in the examples and examples described herein and be within the intended scope of this disclosure, unless otherwise noted) As shown, the CN node 1000 may include network interface circuitry 1007 configured to provide communications with other nodes of the core network and/or the radio access network RAN. The CN node 1000 may also include a processing circuitry 1003 (also referred to as a processor,) coupled to the network interface circuitry, and memory circuitry 1005 (also referred to as memory) coupled to the processing circuitry. The memory circuitry 1005 may include computer readable program code that when executed by the processing circuitry 1003 causes the processing circuitry 1003 to perform operations according to examples disclosed herein. According to other examples, processing circuitry 1003 may be defined to include memory so that a separate memory circuitry is not required.

As discussed herein, operations of the CN node 1000 may be performed by processing circuitry 1003 and/or network interface circuitry 1007. For example, processing circuitry 1003 may control network interface circuitry 1007 to transmit communications through network interface circuitry 1007 to one or more other network nodes and/or to receive communications through network interface circuitry from one or more other network nodes. Moreover, modules may be stored in memory 1005, and these modules may provide instructions so that when instructions of a module are executed by processing circuitry 1003, processing circuitry 1003 performs respective operations (e.g., operations discussed below with respect to Example Examples relating to core network nodes). According to some examples, CN node 1000 and/or an element(s)/function(s) thereof may be embodied as a virtual node/nodes and/or a virtual machine/machines.

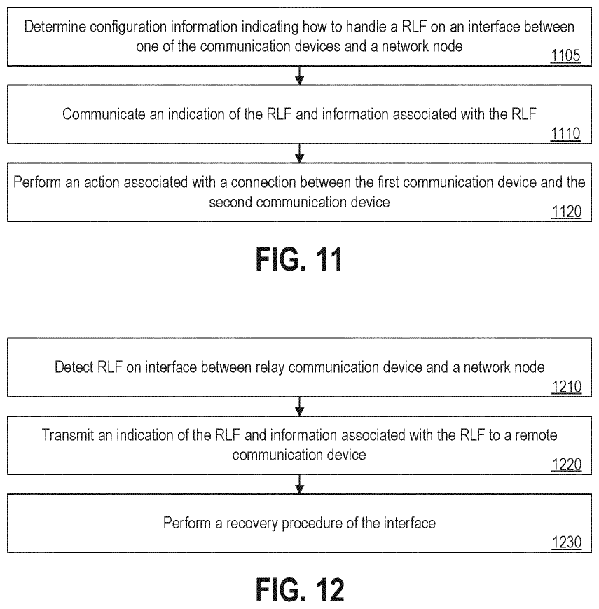

In the description that follows, while the communication device may be any of the communication device 800, wireless device QQ112A, QQ112B, wired or wireless devices UE QQ112C, UE QQ112D, UE QQ200, virtualization hardware QQ504, virtual machines QQ508A, QQ508B, or UE QQ606, the communication device 800 shall be used to describe the functionality of the operations of the communication device. Operations of the communication device 800 (implemented using the structure of the block diagram of FIG. 8) will now be discussed with reference to the flow charts of FIGS. 11-13 according to some examples of inventive concepts. For example, modules may be stored in memory 805 of FIG. 8, and these modules may provide instructions so that when the instructions of a module are executed by respective communication device processing circuitry 803, processing circuitry 803 performs respective operations of the flow charts.

FIG. 11 is a flow chart illustrating an example of operations performed by a first communication device in a communications network with a second communication device for handling radio link failure, RLF, in an interface between the first communication device or the second communication device and a network node in the communications network. In some examples, the interface is a Uu interface.

At block 1105, processing circuitry 803 determines configuration information indicating how to handle the RLF. In some examples, determining the communication information comprises receiving the configuration information via at least one of: system information; a radio resource control, RRC, signal; a media access control, MAC, control element, CE; a paging message; a control packet data unit, PDU, of a protocol layer; and a layer 1, L1, signal. In additional or alternative examples, determining the configuration information includes determining the configuration information based on preconfigured configuration information.

At block 1110, processing circuitry 803 communicates, via transceiver 801, an indication of the RLF and information associated with the RLF with the second communication device. In some examples, the information associated with the RLF includes at least one of: an indication of a carrier where the RLF was detected; an indication of a serving cell in which the RLF was detected; an indication of a cause of the RLF; an indication of how likely the relay communication device is to recover from the RLF while staying in a radio resource control, RRC, connected state; an indication of an estimated interruption period due to the RLF; an indication of a current buffer status of relaying traffic; and an indication of a current buffer status of non-relaying traffic. In additional or alternative examples, the indication of how likely the relay communication device is to recover from the RLF while staying in the RRC connected state includes at least one of: a success probability; an indication of whether a candidate cell has been found by the relay communication device; and an indication of whether the relay communication device intends to perform a RLF recovery.

In additional or alternative examples, communicating the indication of the RLF and information associated with the RLF with the second communication device includes communicating the indication of the RLF and information associated with the RLF with the second communication device via at least one of: a PC5-S interface; a PC5-RRC interface; a media access control, MAC, control element, CE; a control packet data unit, PDU, of a protocol layer; and a layer 1, L1, signal carried on a physical channel.

In additional or alternative examples, communicating the indication of the RLF and the information associated with the RLF includes communicating the indication of the RLF and the information associated with the RLF based on the configuration information.

At block 1120, processing circuitry 803 performs an action associated with a connection between the first communication device and the second communication device. In some examples, performing the action includes performing the action based on the configuration information.

FIG. 12 is a flow chart illustrating an example of the operations of FIG. 11 in which the first communication device is a relay communication device and the second communication device is a remote communication device.

At block 1210, processing circuitry 803 detects the RLF on the interface between the relay communication device and the network node.

At block 1220, processing circuitry 803 transmits, via transceiver 801, an indication of the RLF and information associated with the RLF to the remote communication device.

At block 1230, processing circuitry 803 performs a recovery procedure of the interface. In some examples, performing the recovery procedure includes recovering the interface and, responsive to recovering the interface, transmitting an indication that the interface has been recovered to the remote communication device. In alternative examples, performing the recovery procedure includes failing to recover the interface and, responsive to failing to recover the interface, transmitting an indication that the interface has failed to be recovered to the remote communication device.

In some examples, processing circuitry 803 performs the recovery procedure in response to detecting the RLF and, in response to performing the recovery procedure, transmits the indication of the RLF and the information associated with the RLF.

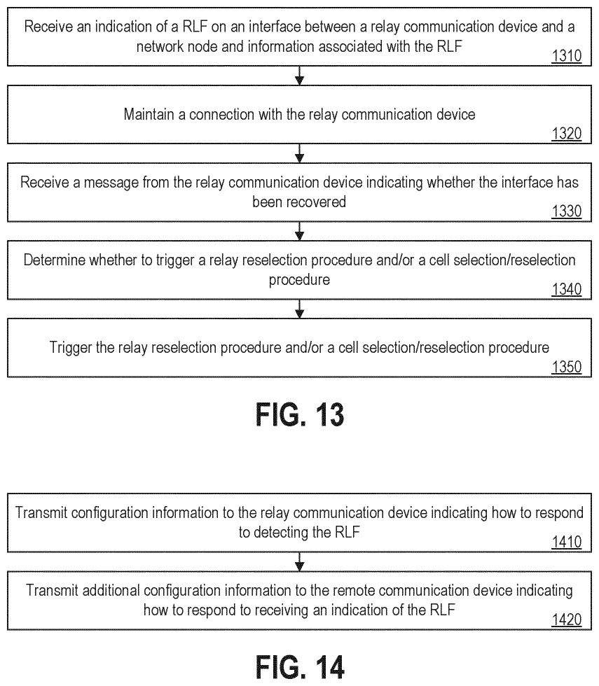

FIG. 13 is a flow chart illustrating an example of the operations of FIG. 11 in which the first communication device is a remote communication device and the second communication device is a relay communication device.

At block 1310, processing circuitry 803 receives, via transceiver 801, an indication of the RLF and information associated with the RLF from the relay communication device.

At block 1320, processing circuitry 803 maintains a connection with the relay communication device.

At block 1330, processing circuitry 803 receives, via transceiver 801, a message from the relay communication device indicating whether the interface has been recovered.

At block 1340, processing circuitry 803 determines whether to trigger a relay reselection procedure and/or a cell selection/reselection procedure. In some examples, determining whether to trigger the relay reselection procedure and/or a cell selection/reselection procedure is based on whether the message indicates that the interface was recovered.

At block 1350, processing circuitry 803 triggers the relay reselection procedure and/or a cell selection/reselection procedure.

In some examples, processing circuitry 803 starts a timer in response to receiving the indication of the RLF. In some examples, the connection with the second communication device is maintained while the timer is running. In additional or alternative examples, in response to determining that the timer has expired, the relay reselection procedure and/or a cell selection/reselection procedure is triggered. In additional or alternative examples, the timer is stopped in response to determining that the relay communication device has recovered from the RLF.

In additional or alternative examples, the timer is determined based on timer configuration information received from at least one of: the relay communication device and the network node. In additional or alternative examples, the timer is determined based on preconfigured timer configuration information.

Various operations from the flow charts of FIGS. 11-13 may be optional with respect to some examples of communication devices and related methods.

Regarding methods of example 1 (set forth below), for example, operations of blocks 1105 of FIG. 11; blocks 1210, 1220, and 1230 of FIG. 12; and blocks 1310, 1320, 1330, 1340, and 1350 of FIG. 13 may be optional.

In the description that follows, while the network node may be any of the RAN node 900, network node QQ110A, QQ1101B, QQ300, QQ606, hardware QQ504, or virtual machine QQ508A, QQ508B, the RAN node 900 shall be used to describe the functionality of the operations of the network node. Operations of the RAN node 900 (implemented using the structure of FIG. 9) will now be discussed with reference to the flow chart of FIG. 14 according to some examples of inventive concepts. For example, modules may be stored in memory 905 of FIG. 9, and these modules may provide instructions so that when the instructions of a module are executed by respective RAN node processing circuitry 903, processing circuitry 903 performs respective operations of the flow chart.

FIG. 14 is a flow chart illustrating an example of operations of a network node in a communications network with a relay communication device and a remote communication device, for handling radio link failure, RLF, in an interface between the network node and relay communication device.

At block 1410, processing circuitry 903 transmits, via transceiver 901, configuration information to the relay communication device, the configuration information indicating how to respond to detecting the RLF. In some examples, the configuration information includes instructions to transmit an indication of the RLF and information associated with the RLF to the remote communication device. In additional or alternative examples, the information associated with the RLF includes at least one of: an indication of a carrier where the RLF was detected; an indication of a serving cell in which the RLF was detected; an indication of a cause of the RLF; an indication of how likely the relay communication device is to recover from the RLF while staying in a radio resource control, RRC, connected state; an indication of an estimated interruption period due to the RLF; an indication of a current buffer status of relaying traffic; and an indication of a current buffer status of non-relaying traffic. In additional or alternative examples, the indication of how likely the relay communication device is to recover from the RLF while staying in the RRC connected state includes at least one of: a success probability; an indication of whether a candidate cell has been found by the relay communication device; and an indication of whether the relay communication device intends to perform a RLF recovery.

At block 1420, processing circuitry 903 transmits, via transceiver 801, additional configuration information to the relay communication device, the additional configuration information indicating how to respond to receiving an indication of the RLF. In some examples, the additional configuration information includes instructions to do at least one of the following in response to receiving the indication of the RLF: maintain the connection with the relay communication device; and trigger a relay reselection procedure and/or a cell selection/reselection procedure.

In some examples, transmitting the configuration information and/or the additional configuration information comprises transmitting the configuration information and/or the additional configuration information via at least one of: system information; a radio resource control, RRC, signal; a media access control, MAC, control element, CE; a paging message; a control packet data unit, PDU, of a protocol layer; and a layer 1, L1, signal.

Various operations from the flow chart of FIG. 14 may be optional with respect to some examples of RAN nodes and related methods. Regarding methods of example 24 (set forth below), for example, operations of blocks 1320 of FIG. 14 may be optional.

FIG. 15 shows an example of a communication system QQ100 in accordance with some examples. The communication system QQ100 includes a network node QQ110B that is communicatively coupled to a hub QQ114, which can be an example of a relay communication device (e.g., communication device 110a). The interface between the network node QQ110B and the hub QQ114 can be referred to as a Uu interface. The hub QQ114 is communicatively coupled to UEs QQ112C-D, which can be examples of remote communication devices (e.g., communication device 110b) and the interface between the hub QQ114 and the UEs QQ112C-D can be referred to as a sidelink interface. Traffic transmitted between the network node QQ110B and one of the UEs QQ112C-D via hub QQ114 can be referred to as relay traffic. In some examples, as further described above, the hub QQ114 can detect a RLF on the Uu interface and transmit an indication of the RLF and information associated with the RLF to one (or both) of the UEs QQ112C-D.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different examples, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices.

Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC). In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some examples, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some examples, the hub QQ114 may be a dedicated hub—that is, a hub whose primary function is to route communications to/from the UEs from/to the network node QQ110b. In other examples, the hub QQ114 may be a non-dedicated hub—that is, a device which is capable of operating to route communications between the UEs and network node QQ110b, but which is additionally capable of operating as a communication start and/or end point for certain data channels.

FIG. 16 shows a UE QQ200 in accordance with some examples. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device.

Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The processing circuitry QQ202 may be configured to communicate with an access network or other network using the communication interface QQ212. The communication interface QQ212 may comprise one or more communication subsystems and may include or be communicatively coupled to an antenna QQ222.

The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

FIG. 17 shows a network node QQ300 in accordance with some examples. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some examples, the network node QQ300 may be configured to support multiple radio access technologies (RATs). In such examples, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

In some examples, the processing circuitry QQ302 includes a system on a chip (SOC). In some examples, the processing circuitry QQ302 includes one or more of radio frequency (RF) transceiver circuitry QQ312 and baseband processing circuitry QQ314. In some examples, the radio frequency (RF) transceiver circuitry QQ312 and the baseband processing circuitry QQ314 may be on separate chips (or sets of chips), boards, or units, such as radio units and digital units. In alternative examples, part or all of RF transceiver circuitry QQ312 and baseband processing circuitry QQ314 may be on the same chip or set of chips, boards, or units.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain examples a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other examples, the communication interface may comprise different components and/or different combinations of components.

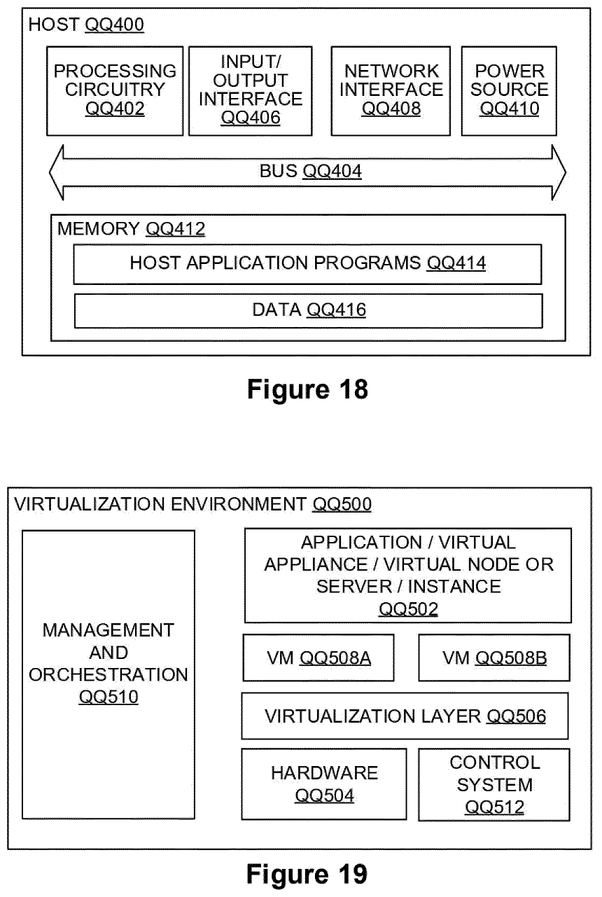

FIG. 18 is a block diagram of a host QQ400, which may be an example of the host QQ116 of FIG. 15, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other examples. Features of these components may be substantially similar to those described with respect to the devices of previous figures, such as FIGS. 16 and 17, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE.

FIG. 19 is a block diagram illustrating a virtualization environment QQ500 in which functions implemented by some examples may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in examples in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the examples disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some examples described herein. The virtualization layer QQ506 may present a virtual operating platform that appears like networking hardware to the VMs QQ508.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some examples, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some examples, some signaling can be provided with the use of a control system QQ512 which may alternatively be used for communication between hardware nodes and radio units.

FIG. 20 shows a communication diagram of a host QQ602 communicating via a network node QQ604 with a UE QQ606 over a partially wireless connection in accordance with some examples. Example implementations, in accordance with various examples, of the UE (such as a UE QQ112a of FIG. 15 and/or UE QQ200 of FIG. 16), network node (such as network node QQ110a of FIG. 15 and/or network node QQ300 of FIG. 17), and host (such as host QQ116 of FIG. 15 and/or host QQ400 of FIG. 18) discussed in the preceding paragraphs will now be described with reference to FIG. 20.

Like host QQ400, examples of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 15) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some examples, the user data is associated with a particular human user interacting with the UE QQ606. In other examples, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the examples described throughout this disclosure. Accordingly, in step QQ612, the network node QQ604 transmits to the UE QQ606 the user data that was carried in the transmission that the host QQ602 initiated, in accordance with the teachings of the examples described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the examples described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various examples improve the performance of OTT services provided to the UE QQ606 using the OTT connection QQ650, in which the wireless connection QQ670 forms the last segment. More precisely, the teachings of these examples may improve a remote UE's ability to respond to a Uu RLF and thereby provide benefits such as improved network reliability and reduced user wait time due to long connectivity interruptions.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more examples improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some examples, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain examples, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other examples may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain examples, some or all of the functionality described herein may be provided by processing circuitry executing instructions stored on in memory, which in certain examples may be a computer program product in the form of a non-transitory computer-readable storage medium. In alternative examples, some or all of the functionality may be provided by the processing circuitry without executing instructions stored on a separate or discrete device-readable storage medium, such as in a hard-wired manner. In any of those particular examples, whether executing instructions stored on a non-transitory computer-readable storage medium or not, the processing circuitry can be configured to perform the described functionality.

The benefits provided by such functionality are not limited to the processing circuitry alone or to other components of the computing device, but are enjoyed by the computing device as a whole, and/or by end users and a wireless network generally.

### Examples

### Group A Examples

1. A method performed by a first communication device in a communications network with a second communication device for handling radio link failure, RLF, in an interface between the first communication device or the second communication device and a network node in the communications network, the method comprising:
   communicating (1110) an indication of the RLF and information associated with the RLF with the second communication device; and
   performing (1120) an action associated with a connection between the first communication device and the second communication device.
2. The method of Example 1, wherein the first communication device is a relay communication device,
   wherein the second communication device is a remote communication device,
   wherein communicating the indication of the RLF and the information comprises transmitting (1220) the indication of the RLF and information associated with the RLF to the second communication device.
3. The method of Example 2, wherein performing the action comprises performing (1230) a recovery procedure of the interface.
4. The method of Example 3, wherein performing the recovery procedure comprises recovering the interface, and
   wherein performing the action further comprises, responsive to recovering the interface, transmitting an indication that the interface has been recovered to the remote communication device.
5. The method of Example 3, wherein performing the recovery procedure comprises failing to recover the interface, and
   wherein performing the action further comprises, responsive to failing to recover the interface, transmitting an indication that the interface has failed to be recovered to the remote communication device.
6. The method of any of Examples 2-5, wherein performing the action comprises slowing or suspending transmission and/or reception of relay traffic between the relay communication device and the remote communication device, the relay traffic being traffic transmitted between the remote communication device and the network node via the relay communication device.
7. The method of any of Examples 2-6, wherein performing the action comprises responsive to detecting the RLF, performing the action, and
   wherein transmitting the indication of the RLF and the information associated with the RLF to the remote communication device comprises, responsive to performing the action, transmitting the indication of the RLF and the information associated with the RLF to the remote communication device.
8. The method of Example 1, wherein the first communication device is a remote communication device,
   wherein the second communication device is a relay communication device, and
   wherein communicating the indication of the RLF and the information comprises receiving (1310) the indication of the RLF and the information associated with the RLF from the relay communication device.
9. The method of Example 8, wherein performing the action comprises performing the action based on at least one of:
   a quality of service, QoS, requirement of relay traffic between the remote communication device and the relay communication device, the relay traffic being traffic transmitted between the remote communication device and the network node via the relay communication device; and
   a type of the relay traffic.
10. The method of Example 8, wherein performing the action comprises maintaining (1320) the connection with the relay communication device.
11. The method of Example 10, wherein maintaining the connection further comprises:
   receiving (1330) a message from the relay communication device indicating whether the interface has been recovered; and
   determining (1340) whether to trigger a relay reselection procedure and/or a cell selection/reselection procedure based on the message.
12. The method of Example 8, wherein performing the action comprises triggering (1350) a relay reselection procedure and/or a cell selection/reselection procedure.
13. The method of any of Examples 8-12, wherein performing the action comprises: starting a timer; and
   maintaining (1320) the connection with the second communication device while the timer is running.
14. The method of Example 13, wherein performing the action further comprises: determining that the timer has expired; and
   responsive to determining that the timer has expired, triggering (1350) a relay reselection procedure and/or a cell selection/reselection procedure.
15. The method of Example 13, wherein performing the action further comprises:
   determining that the relay communication device has recovered from the RLF before the timer expires; and
   stopping the timer.
16. The method of any of Examples 13-15, wherein the timer is determined based on timer configuration information received from at least one of: the relay communication device and the network node
17. The method of any of Examples 13-15, wherein the timer is determined based on preconfigured timer configuration information.
18. The method of any of Examples 2-17, wherein the information associated with the RLF comprises at least one of:
   an indication of a carrier where the RLF was detected;
   an indication of a serving cell in which the RLF was detected;
   an indication of a cause of the RLF;
   an indication of how likely the relay communication device is to recover from the RLF while staying in a radio resource control, RRC, connected state;
   an indication of an estimated interruption period due to the RLF;
   an indication of a current buffer status of relay traffic; and
   an indication of a current buffer status of non-relay traffic.
19. The method of Example 18, wherein the indication of how likely the relay communication device is to recover from the RLF while staying in the RRC connected state comprises at least one of:
   a success probability;
   an indication of whether a candidate cell has been found by the relay communication device; and
   an indication of whether the relay communication device intends to perform a RLF recovery.
20. The method of any of Examples 1-19, where communicating the indication of the RLF and information associated with the RLF with the second communication device comprises communicating the indication of the RLF and information associated with the RLF with the second communication device via at least one of:
   a PC5-S interface;
   a PC5-RRC interface;
   a media access control, MAC, control element, CE;
   a control packet data unit, PDU, of a protocol layer; and
   a layer 1, L1, signal carried on a physical channel.
21. The method of any of Examples 1-20, further comprising:
   determining (1105) configuration information from the second communication device or the network node,
   wherein communicating the indication of the RLF and the information associated with the RLF comprises communicating the indication of the RLF and the information associated with the RLF based on the configuration information; and
   wherein performing the action comprises performing the action based on the configuration information.
22. The method of Example 21, wherein determining the communication information comprises receiving the configuration information via at least one of: system information;
   a radio resource control, RRC, signal;
   a media access control, MAC, control element, CE;
   a paging message;
   a control packet data unit, PDU, of a protocol layer; and
   a layer 1, L1, signal.
23. The method of Example 21, wherein determining the configuration information comprises determining the configuration information based on preconfigured configuration information.
24. The method of any of Examples 1-23, wherein the interface is a Uu interface.

### Group B Examples

26. A method performed by a network node in a communications network with a relay communication device and a remote communication device, for handling radio link failure, RLF, in an interface between the network node and relay communication device, the method comprising:
   transmitting (1410) configuration information to the relay communication device, the configuration information indicating how to respond to detecting the RLF.
27. The method of Example 26, wherein the configuration information comprises instructions to transmit an indication of the RLF and information associated with the RLF to the remote communication device.
28. The method of Example 27, wherein the information associated with the RLF comprises at least one of:
   an indication of a carrier where the RLF was detected;
   an indication of a serving cell in which the RLF was detected;
   an indication of a cause of the RLF;
   an indication of how likely the relay communication device is to recover from the RLF while staying in a radio resource control, RRC, connected state;
   an indication of an estimated interruption period due to the RLF;
   an indication of a current buffer status of relay traffic; and
   an indication of a current buffer status of non-relay traffic.
29. The method of Example 28, wherein the indication of how likely the relay communication device is to recover from the RLF while staying in the RRC connected state comprises at least one of:
   a success probability;
   an indication of whether a candidate cell has been found by the relay communication device; and
   an indication of whether the relay communication device intends to perform a RLF recovery.
30. The method of any of Examples 26-29, further comprising:
   transmitting (1420) additional configuration information to the remote communication device, the additional configuration information indicating how to respond to receiving an indication of the RLF.
31. The method of Example 30, wherein the additional configuration information comprises instructions to do at least one of the following in response to receiving the indication of the RLF:
   maintain the connection with the relay communication device; and
   trigger a relay reselection procedure and/or a cell selection/reselection procedure.
32. The method of any of Examples 26-31, wherein transmitting the configuration information and/or the additional configuration information comprises transmitting the configuration information and/or the additional configuration information via at least one of:
   system information;
   a radio resource control, RRC, signal;
   a media access control, MAC, control element, CE;
   a paging message;
   a control packet data unit, PDU, of a protocol layer; and
   a layer 1, L1, signal.

### Group C Examples

34. A first communication device (800) in a communications network with a second communication device (800) for handling radio link failure, RLF, in an interface between the first communication device or the second communication device and a network node (900) in the communications network, the first communication device comprising:
   processing circuitry (803) configured to perform any of the operations of any of the Group A examples; and
   power supply circuitry configured to supply power to the processing circuitry.
35. A network node (900) in a communications network with a relay communication device (800) and a remote communication device (800), for handling radio link failure, RLF, in an interface between the network node and relay communication device, the network node comprising:
   processing circuitry (903) configured to perform any of the operations of any of the Group B examples;
   power supply circuitry configured to supply power to the processing circuitry.
36. A first communication device in a communications network with a second communication device for handling radio link failure, RLF, in an interface between the first communication device or the second communication device and a network node in the communications network, the first communication device comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the operations of any of the Group A examples;
   an input interface connected to the processing circuitry and configured to allow input of information into the first communication device to be processed by the processing circuitry;
   an output interface connected to the processing circuitry and configured to output information from the first communication device that has been processed by the processing circuitry; and
   a battery connected to the processing circuitry and configured to supply power to the first communication device.
37. A first communication device (800) in a communications network with a second communication device (800) for handling radio link failure, RLF, in an interface between the first communication device or the second communication device and a network node (900) in the communications network, the first communication device comprising:
   processing circuitry (803); and
   memory (805) coupled to the processing circuitry and having instructions stored therein that are executable by the processing circuitry to cause the first communication device to perform any of the operations of Examples 1-24.
38. A network node (900) in a communications network with a relay communication device (800) and a remote communication device (800), for handling radio link failure, RLF, in an interface between the network node and relay communication device, the network node comprising:
   processing circuitry (903); and
   memory (905) coupled to the processing circuitry and having instructions stored therein that are executable by the processing circuitry to cause the network node to perform any of the operations of Examples 25-31.
39. A computer program comprising program code to be executed by processing circuitry (803) of a first communication device (800) in a communications network with a second communication device (800) for handling radio link failure, RLF, in an interface between the first communication device or the second communication device and a network node (900) in the communications network, whereby execution of the program code causes the first communication device to perform operations according to any of Examples 1-24.
40. A computer program comprising program code to be executed by processing circuitry (903) of a network node (900) in a communications network with a relay communication device (800) and a remote communication device (800), for handling radio link failure, RLF, in an interface between the network node and relay communication device, whereby execution of the program code causes the network node to perform operations according to any of Examples 25-31.
41. A computer program product comprising a non-transitory storage medium including program code to be executed by processing circuitry (803) of a first communication device (800) in a communications network with a second communication device (800) for handling radio link failure, RLF, in an interface between the first communication device or the second communication device and a network node (900) in the communications network, whereby execution of the program code causes the first communication device to perform operations according to any of Examples 1-24.
42. A computer program product comprising a non-transitory storage medium including program code to be executed by processing circuitry (903) of a network node (900) in a communications network with a relay communication device (800) and a remote communication device (800), for handling radio link failure, RLF, in an interface between the network node and relay communication device, whereby execution of the program code causes the network node to perform operations according to any of Examples 25-31.

1. A method performed by a Layer 2, L2, UE-to-Network Relay User Equipment, UE, in a mobile telecommunication network, wherein said Relay UE is arranged to provide functionality to support connectivity for a remote UE in said mobile telecommunication network, said method comprising:
detecting, by said Relay UE, a Radio Link Failure, RLF, in an interface between the Relay UE and a network node of the mobile telecommunication network;
upon detection of said RLF, signalling, by said Relay UE, at least one of the following information to said remote UE;
1) RLF has been detected by said Relay UE;
2) said Relay UE has recovered from said detected RLF; and
3) said Relay UE has not recovered from said detected RLF.

2. A method in accordance with claim 1, wherein said signalling further comprises:
transmitting, by said Relay UE, an indication of the RLF and information associated with the RLF to said remote UE.

3. A method in accordance with claim 1, wherein said method comprises:
performing, by said Relay UE, a recovery procedure of said interface between said Relay UE and said network node of said mobile telecommunication network.

4. A method in accordance with claim 3, wherein said signalling comprises:
signalling, by said Relay UE, responsive to recovering the interface, an indication that said interface has been recovered.

5. A method in accordance with claim 3, wherein said signalling comprises:
signalling, by said Relay UE, responsive to failing to recover said interface, an indication that said interface has failed to be recovered.

6. A method in accordance with claim 1, wherein said method further comprises:
slowing or suspending, by said relay UE, transmission and/or reception of relay traffic between the Relay UE and the remote UE, wherein said relay traffic being traffic transmitted between the Remote UE and the network node via the Relay UE.

7. A method performed by a remote User Equipment in a mobile telecommunication network, wherein said remote UE has a connection to a mobile telecommunication via a Layer 2, L2, UE-to-Network Relay User Equipment, UE, in said mobile telecommunication network, wherein said Relay UE is arranged to provide functionality to support connectivity for said remote UE in said mobile telecommunication network, said method comprising:
receiving, by said remote UE, from said Relay UE, at least one of the following information:
1) RLF has been detected by said Relay UE;
2) said Relay UE has recovered from said detected RLF;
3) said Relay UE has not recovered from said detected RLF;
performing, by said remote UE, an action associated with a connection between the remote UE and the Relay UE.

8. A method in accordance with claim 7, wherein receiving further comprises:
receiving, by said remote UE, an indication of the RLF and information associated with the RLF to said remote UE.

9. A method in accordance with claim 7, wherein said performing the action comprises:
maintaining, by said remote UE, the connection with the Relay UE.

10. A method in accordance with claim 7, wherein said method further comprises:
receiving a message from the Relay UE indicating whether the interface has been recovered; and
determining whether to trigger a relay reselection procedure and/or a cell selection/reselection procedure based on said message.

11. A method in accordance with claim 7, wherein said performing said action comprises:
triggering, by said remote UE, a relay reselection procedure and/or a cell selection/reselection procedure.

12. A method in accordance with claim 7, wherein performing said action comprises:
starting a timer; and
maintaining said connection with the Relay UE while the timer is running.

13. A method in accordance with claim 12, wherein said performing said action further comprises:
determining that said timer has expired; and
responsive to determining that said timer has expired, triggering a relay reselection procedure and/or a cell selection/reselection procedure.

14. A method in accordance with claim 12, wherein said performing said action further comprises:
determining that said Relay UE has recovered from said RLF before said timer expires, and
stopping said timer.

15. A Layer 2, L2, UE-to-Network Relay User Equipment, UE arranged to operate in a mobile telecommunication network, wherein said Relay UE is arranged to provide functionality to support connectivity for a remote UE in said mobile telecommunication network, said Relay UE comprising:
processing circuitry configured to perform any of the operations of claim 1; and
power supply circuitry configured to supply power to the processing circuitry.

16. A remote User Equipment, UE, arranged to operate in a mobile telecommunication network, wherein said remote UE has a connection to a mobile telecommunication via a Layer 2, L2, UE-to-Network Relay User Equipment, UE, in said mobile telecommunication network, wherein said Relay UE is arranged to provide functionality to support connectivity for said remote UE in said mobile telecommunication network, said remote UE comprising:
processing circuitry configured to perform any of the operations of claim 7;
power supply circuitry configured to supply power to the processing circuitry.

17. A vehicle comprising a remote User Equipment, UE, arranged to operate in a mobile telecommunication network, said vehicle comprising:
processing circuitry configured to perform any of the operations of claim 7;
power supply circuitry configured to supply power to the processing circuitry.

18. A vehicle comprising a Relay User Equipment, UE, arranged to operate in a mobile telecommunication network, said vehicle comprising:
processing circuitry configured to perform any of the operations of claim 1;
power supply circuitry configured to supply power to the processing circuitry.

19. A computer program product comprising a computer readable medium having instructions stored thereon which instructions, when executed by a User Equipment, UE, of a mobile telecommunication network, cause said UE to implement a method in accordance with claim 1.
